(19) United States
(12) Patent Application Publication
(10) Pub. No.: US 2006/0007321 A1
(43) Pub. Date: Jan. 12, 2006

(54) A Distributed Image and Signal Processing Apparatus For Camera Phone Applications

(76) Inventor: David Huai, ShenZhen, CA (CN)

Correspondence Address: David Huai, 251 S. Lake Ave. 6th Floor, Pasadena, CA, 91101, US

(21) Appl. No.: 10/907,264

(22) Filed: Mar. 26, 2005

(51) Int. Cl. H04N 5/228

(52) U.S. Cl. 348/222.1

(57) ABSTRACT

A distributed image and signal processing apparatus for camera function within a mobile phone, which utilizes the system memory and host ADSP to conduct bitmap fine processing as part of the camera sub-system, in addition to a dedicated hardware ISP(image and signal processor) front end. This apparatus enables ISP to be designed with a low cost, yet capable of advanced functionalities.

### FIELD OF INVENTION

Image and signal processing for camera phones.

### BACKGROUND

Definition of terms

ISP (image and signal processor)

It comprises of the HW pipeline, a microprocessor, control logic, embedded memories and addressable memories, that process sensor raw data and output YCbCr or other standard image data. Its predominant operation mode is slave

Camera DSP

It comprises of all the function modules of an ISP, with an optional high performance DSP core and frame buffers to conduct real time frame bitmap processing, as well as compression engines and external interface to LCD, strobe, flash storage, PC or TV. A camera DSP should be capable of supporting all the functions of a digital camera.

ADSP (Application DSP)

A 32 bit high performance RISC processor with full capability for system control and real-time multimedia applications running on a mobile phone, except those functions by Baseband processor, which focuses on wireless communications. For the camera function, it usually takes in formatted processed image stream, delivers it after further processing to local storage or remote destination. Vendors include TI (Omap), Intel (PXA270), Zoran (Approach), and Samsung (S3C24A0). 16 bit counterparts or stand-alone enhanced Baseband processor with multimedia functions also exist, which play similar role to ADSP as far as the ISP function described here.

Sensor Raw Data

R, G, B Bayer or other CFA (color filter array) patterned data generated at the photo cell

The evolution of camera function implemented in the mobile phones is as follows:

Single chip solution for VGA and below resolution, the image quality of which is barely acceptable. The following focuses on mega pixel and above:

The cascaded combination of the three stand-alone modules- sensor, camera DSP and ADSP. Advantage: least efforts and good quality. Disadvantage: high material and space cost

Stand-alone cost-down ISP in place of a camera DSP. This is one step to improve the gate efficiency by getting rid of redundant or unnecessary components.

Integrated ISP with the image sensor. The gate and space efficiency is enhanced further. However, to avoid sensor chip being over sized and to reduce the cost, it has to drop components such as frame buffers and rather expensive RISC processor core, which are necessary to achieve high image quality and performance. The trade-off is cost and size vs. performance and quality

Integrated ADSP with direct sensor interface. To integrate the camera DSP function into an ADSP is another approach to gate efficiency. From business perspective, there seems to be a battle between the sensor and ADSP for ISP module. There are pros and cons for each side. Being the source of the source, the sensor manufacturer could be in a position to match their sensor with an effective ISP. However, because the space and computing resource is limited, so is the image quality and performance in current art. This situation is aggravated when 2M pixel and above camera phones become the main stream. ADSPs on the other hand have memory space and computing resource that matches or even out-perform a high-end consumer digital camera. The shortfall is that more integration implies more risk, that one weak module would impact its overall market value. Sensor chip vendors always has a back-up plan of raw data output in case its own ISP does not meet the goal, but ADSP can not. Because color processing is a both subjective and objective measure, it is difficult to come up with a prevailing design in the fast moving market window.

### SUMMARY OF INVENTION

As the mobile phone market migrates from 2G to 3G, more multimedia applications are enabled along with camera functions, which result in enhanced Baseband processors or dedicated multimedia processors or multimedia co-processors, and most of them have ITU CCIR656 YCbCr standard camera interface. The system SDRAM memory size also increases to accommodate such applications. In camera mode, with limited background messaging service and incoming call handling in addition to post-processing of image stream, a significant portion of the system resource are still available. Although ISPs and ADSPs could come from different vendors, they are subsystems in a camera phone. This invention describes an optimal distributed ISP solution to use this available resource for camera fine-tuning, which maximizes performance at minimal cost. By focused efforts on improvements in hardware pipelines of the ISP and deploying bitmap processing and machine vision assisted content based camera tuning in host ADSP, this apparatus ensures a sustainable refine roadmap for camera chips and stand-alone ISPs to enable a realization of true professional digital camera in camera phones.

### DETAILED DESCRIPTION OF THE INVENTION

Partition the image processing functions for an image sensor in a camera module of a camera phone into three categories: the hardware pipeline and control logic circuitry (HWP), the camera control and hardware filtered patch data software processing (SWI) and bitmap based software processing (SW2). Hardware filtered patch data are intermediate results from hardware filtering of
(1) Entire frame or portions of frame of original sensor raw data or
(2) Intermediate data stream in the hardware pipeline. It is typically a scalar or one-dimensional vector.

Bitmap is entire or down-sampled frame, or portion of entire or down-sampled frame of raw or processed data. It is a two dimensional array. Bitmap can be in compressed format. An example can show the orders of difference between the hardware filtered patch data and bitmap. In automatic exposure, it is a common practice to separate entire screen into sub-windows, say 64. The hardware will compute in real time the weighted average luminance of these 64 windows for SWI to make some decision. So here the patch size is 64*2. For a sensor of two mega pixels (1800*1200), VGA resolution is common in preview mode, where the bitmap size will be 640*480*2, a 4800 times difference. Software processing of bitmap demands not only much higher computing power, but also frame buffers.

Integrate HWP and SW1 as an ISP module (referred to as ISP hereafter), which could be either further integrated with image sensor in a single camera chip, or packaged as a stand-alone IC, having hardware pipeline, a micro controller and control logic, and embedded memories excluding frame buffers.

Integrate HWP and SW1 as an ISP module (referred to as ISP hereafter), which could be either further integrated with an image sensor in a single camera chip, or packaged as a stand-alone IC, having hardware pipeline, a micro controller and control logic, and embedded memories excluding frame buffers.

The ISP can do course processing and generate YCbCr or other standard output, while sensor raw data and optional hardware filtered data are ported simultaneously to host ADSP for bitmap level processing and other heavy-duty computations, the results of which are feedback to the ISP through ISP-host ADSP control bus to fine tune the registers, the parameters, the pathways and other control logics of the ISP for best image quality and performance. Tasks for SW2 include noise analysis, automatic white balance (AWB), automatic exposure (AE), automatic focus (AF), and pattern classification based scene analysis, which serve as the reference for automatic adjustments and camera controls. For example, for AWB adjustment, computing hardware weighted averaged windowed R, G, and B values is a common implementation for low or middle end digital cameras, and an 8 bit micro controller can handle it. For the same AWB adjustment task, a high performance RISC processor can do much better in accuracy of the rendition; by adaptively conducting bitmap level processing of pixel-by-pixel weighted data. Further, a machine vision based scene analysis that can de-correlate the ambient background color from the color temperature of the predominant light source, and detect the existence of human objects could lead to finer and more pleasing results by applying adaptive algorithms. Other examples include glare detection for AE, and face-priority AF. Besides bitmap, host ADSP could further offload ISP by processing hardware-filtered data and control camera directly, for faster convergence or more aggressive cost-down.

The raw sensor data can be fed into host ADSP in such a way that raw data and processed YCbCr or other format standard data share the same camera interface with the ADSP, but in interleaved frames. The ratio and position of two streams in the mixed output is adjustable. To insure there is no degradation on frame rate for preview or video capture, multiple channel or higher speed sensor readout scheme could be implemented. An alternative data link is via DMA transfer from ISP to system memory. As a simplified implementation, the host ADSP can process the YCbCr or other format standard output data instead of raw data from the ISP for fine processing. This might reduce the accuracy and efficacy, but will reduce the efforts of the implementation as well

When optionally fine processing is carried out on the processed output data of the ISP instead of raw sensor data, it differs from generic post-processing in previous art in that the former serves as an extended function module participating in image rendition at the hardware pipeline level, while latter focuses on the after effects and how to use the information within the image.

ISP should be able to deliver course YCbCr or other format standard data by its own without the host participating in. In addition, its manufacturer needs to develop a driver or protocol for its communication with the host ADSP and an image processing library to be ported to host ADSP. Further, it could be made a partially open or completely open system by allowing for libraries implemented by third parties.

There are three operation modes.
(1) Bypass mode-wherein raw sensor data is downloaded from the sensor and directly output to the host ADSP virtually unprocessed;
(2) Stand-alone mode-wherein ISP does course processing and generate YCbCr or other format standard data stream without fine processing and
(3) Shared mode-wherein the course processing and fine processing collaborate to complete the image processing function.

The advantage of this distributed apparatus is multifold:
(1) Maximized computing power by utilizing host ADSP resource
(2) Minimized cost and space. ISP does not need frame buffer, nor high performance RISC processor, the cost and space could be minimized.
(3) Applicable scene analysis assisted camera tuning
(4) Optimize the hardware design. Moving the need for frame buffers or high performance RISC processor core in ISP reduces cost, space and design efforts. Thereby there are more room for dedicated improvements on pipeline rendering, and line buffers that has to grow as resolution grows.
(5) Three levels of processing-ISP stand-alone, host ADSP assisted, and customer designed host process. It offers a flexible range of implementations

### BRIEF DESCRIPTION OF DRAWINGS

FIG. 1. illustrates the system components and the signal and control data path. The forward data path starts from the sensor raw data in sensor 1, the ISP 2 downloads it and loads into hardware pipeline 8. The micro controller 4 reads the hardware filtered patch data via ISP 2 local bus for course processing or send it to the host ADSP 4 via interleave module or ISP-host ADSP control bus for fine processing. Processed data stream from the hardware pipeline is mixed with raw data stream at the interleave module and sent to host ADSP 4 via camera interface. The driver on the host ADSP 4 separates the raw data and processed data and directs them to fine processing or post-processing for display, storage or real time applications. The host ADSP conducts fine processing using its core 6, system memory 10 and other system resource, and send the control and results to ISP 2 via ISP-host ADSP control bus.

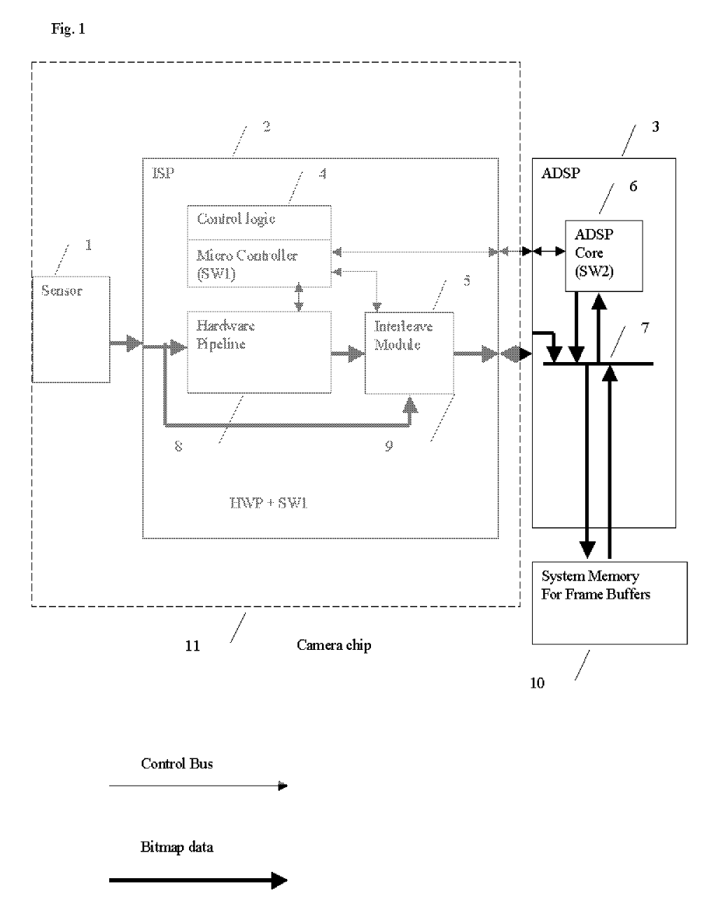

FIG. 2. is a flow chart for a preferred embodiment of this apparatus. Portrait Mode is one of the advanced features for professional photography, wherein camera settings are optimized for human objects. In most of the implementations found in high end digital cameras today, this mode is entered when the user manually selects it before a capture, which is not so convenient. FIG. 2. illustrates a scene analysis based AUTOMATIC PORTRAIT MODE that could be a default setting for camera operation, wherein orchestrated processing is carried out by ISP and host ADSP for fine AF, AE, and AWB adjustments.

What is claimed is:

1. A distributed apparatus for image and signal functions in camera module of camera phones, wherein course processing is implemented in ISP and fine processing is implemented in the host ADSP.

2. In claim 1, said ISP comprise hardware pipeline, a micro controller, control logic, and embedded memories excluding frame buffers.

3. In claim 1, said course processing comprises processing by hardware pipeline and camera control and tuning based upon processing hardware filtered patch data by the control unit embedded in the said ISP of claim 2.

4. In claim 1, said fine processing comprises host ADSP processing the bitmap of the raw data, the hardware filtered patch data, and the processed output data stream from the said ISP module in compressed or uncompressed format to generate control data to be feedback to the said ISP via ISP-host ADSP control bus to fine tune the registers, the parameters, the pathways and other control logics of the said ISP for best image quality and performance.

5. In claim 4, said fine processing comprises pixel level statistical computation as well as pattern classification based scene analysis, such that the fine settings for said ISP could be geared toward the content and the settings of the shot.

6. In said apparatus of claim 1, the forward data path (from said ISP to host ADSP) comprises:
(1) Multiple channel or high speed read-out from the sensor to said ISP
(2) Interleave the raw data stream frame (optionally down-sampled or windowed) with the processed data stream frame
(3) Output the mixed data stream to the host ADSP via host ADSP camera interface.

7. In said apparatus of claim 1, the alternative forward data path is via DMA transfer from said ISP to system memory.

8. In claim 6, said camera interface comprise a high-speed parallel bus.

9. In said apparatus of claim 1, the backward data path (from host ADSP to said ISP) uses the ISP-host ADSP control bus.

10. In claim 8, said control bus is a serial bus.

11. In said apparatus of claim 1, there are three operation modes
(1) Bypass mode, wherein raw sensor data is downloaded from the sensor and directly output to the host ADSP, virtually unprocessed;
(2) Stand-alone mode, wherein ISP does said course processing and generate output data stream without said fine processing and
(3) Shared mode, wherein the said course processing and fine processing collaborate to complete the image processing function.

12. In said apparatus of claim 1, a driver is responsible for communications between said ISP and the host ADSP. Furthermore, the algorithms implemented in said fine processing could be
(1) Implemented and ported to host ADSP by the manufacturer of said ISP, or
(2) Implemented by the phone system integrator, or
(3) Implemented or ported by third parties;
(4) The above implementations could coexist in real time, and be dynamically invoked and switched on/off.

13. In said apparatus of claim 1, host ADSP comprises 32 bit ADSP, 16 bit or 32 bit multimedia application coprocessors, or stand-alone Baseband processors with enhanced multimedia functions, that have YCbCr or other format standard camera input interface.

14. A derivative of said apparatus of claim 1 applies to camera applications other than camera phones, where high performance computing resource is immediately available in an embedded system so as to be the host processor in place of the ADSP for said ISP.

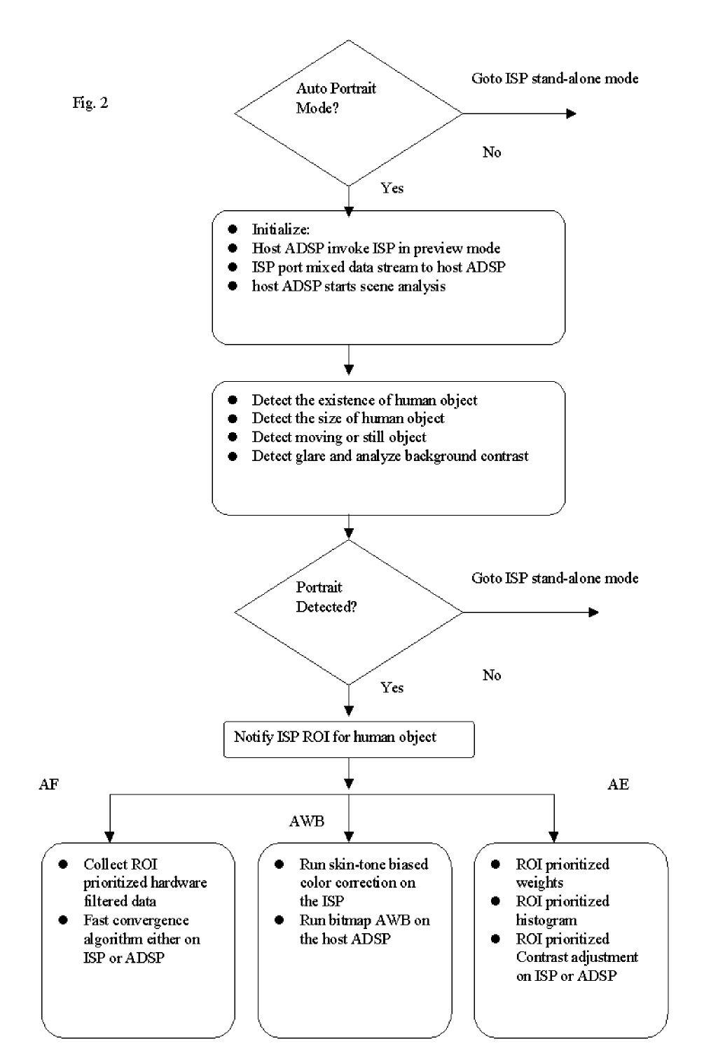

15. The automatic portrait mode as describe in paragraph 29 and FIG. 2.
